(19) United States
(12) Patent Application Publication
(10) Pub. No.: US 2025/0005613 A1
(43) Pub. Date: Jan. 2, 2025

(54) INFORMATION PROCESSING DEVICE, DISPLAY SYSTEM, AND INFORMATION PROCESSING METHOD

(71) Applicant: Sharp NEC Display Solutions, Ltd., Tokyo (JP)

(72) Inventor: Akira UCHIYAMA, Tokyo (JP)

(21) Appl. No.: 18/883,571

(22) Filed: Sep. 12, 2024

Related U.S. Application Data
(63) Continuation of application No. PCT/JP2022/013462, filed on Mar. 23, 2022.

(51) Int. Cl. G06Q 30/0207; G06Q 30/0241

(52) U.S. Cl. CPC G06Q 30/0207; G06Q 30/0241

(57) ABSTRACT

An information processing device includes a first product extracting unit configured to extract a first product having a first discount rate which is equal to or greater than a first threshold value. The information processing device further includes a second product extracting unit configured to extract a second product having a second discount rate which is less than the first discount rate of the first product. The information processing device further includes a content creating unit configured to create advertisement-contents for advertising the first product and the second product together.

### TECHNICAL FIELD

The present invention relates to an information processing device, a display system, and an information processing method.

### BACKGROUND ART

In stores (for example, grocery stores) in which food products are handled, discard of products due to reaching of a use-by-date or an expiration date or overstocking causes a great loss. Accordingly, stores may sell products at a discount from predetermined prices thereof. At this time, stores may want to sell products with high discount rates promptly even when sales profits thereof are decreased. Accordingly, when there are a plurality of discounted products, it may be wanted to preferentially sell products with higher discount rates.

On the other hand, there is a technique of preparing content for notification or advertisement of products designated by a store side and displaying the content on a display monitor installed in the store.

For example, Patent Document 1 discloses a technique of extracting products which are close to reaching of use-by-dates or expiration dates thereof and which have a high likelihood of discount in the future, dynamically preparing content, and displaying the content on a display monitor in order to preferentially sell the products before discount thereof. However, for example, in stores (for example, grocery stores), there may be a plurality of products to be discounted almost simultaneously as described above. In this case, it is not efficient to individually notify of the plurality of products to be discounted. On the other hand, when products without a large difference in discount rate are simultaneously notified of, a bargain feeling in products based on the discount fades and it may be difficult to concentrate purchase desires of consumers on products with higher discount rates. Accordingly, there is a likelihood that an effect of discount in the stores will not be sufficient.

### CITATION LIST

### Patent Document

### Patent Document 1

Japanese Unexamined Patent Application, First Publication No. 2010-97439

### SUMMARY OF INVENTION

### Technical Problem

There is a problem in that it is not possible to notify of a plurality of products to be discounted together and to concentrate purchase desires of consumers on products with high discount rates.

### Solution to Problem

According to an aspect of the present invention, there is provided an information processing device including: a first product extracting unit configured to extract a first product of which a discount rate is equal to or greater than a first threshold value; a second product extracting unit configured to extract a second product of which a discount rate is less than the discount rate of the first product; and a content creating unit configured to create content for advertising the first product and the second product together.

According to another aspect of the present invention, there is provided a display system including: a first product extracting unit configured to extract a first product of which a discount rate is equal to or greater than a first threshold value; a second product extracting unit configured to extract a second product of which a discount rate is less than the discount rate of the first product; a content creating unit configured to create content for advertising the first product and the second product together; and a display device configured to display the created content.

According to another aspect of the present invention, there is provided an information processing method that is performed by a computer, the information processing method including: a first product extracting step of extracting a first product of which a discount rate is equal to or greater than a first threshold value; a second product extracting step of extracting a second product of which a discount rate is less than the discount rate of the first product; and a content creating step of creating content for advertising the first product and the second product together.

### Advantageous Effects of Invention

According to the present invention, it is possible to notify of a plurality of products to be discounted together and to concentrate purchase desires of consumers on products with high discount rates.

### BRIEF DESCRIPTION OF DRAWINGS

FIG. 1 is a diagram schematically illustrating a configuration of a display system according to an embodiment of the present invention.

FIG. 2 is a block diagram schematically illustrating a functional configuration of an information processing device according to the embodiment of the present invention.

FIG. 3 is a diagram schematically illustrating a data structure and a data example of a product database according to the embodiment of the present invention.

FIG. 4 is a diagram schematically illustrating an example of extraction results of products to be discounted according to the embodiment of the present invention.

FIG. 5 is a diagram schematically illustrating an example of extraction results of first products of which sales are preferentially promoted according to the embodiment of the present invention.

FIG. 6 is a diagram schematically illustrating an example of extraction results of second products which are advertised along with the first products according to the embodiment of the present invention.

FIG. 7 is a diagram schematically illustrating an example of combinations of first products and second products which are advertised together according to the embodiment of the present invention.

FIG. 8 is a diagram illustrating an example of an image of content of an advertisement according to the embodiment of the present invention.

FIG. 9 is a flowchart illustrating an operation flow of a display process that is performed by the information processing device according to the embodiment of the present invention.

FIG. 10 is a diagram illustrating an example of a configuration illustrating another aspect of the information processing device according to the present invention.

### DESCRIPTION OF EMBODIMENTS

Hereinafter, an embodiment of the present invention will be described.

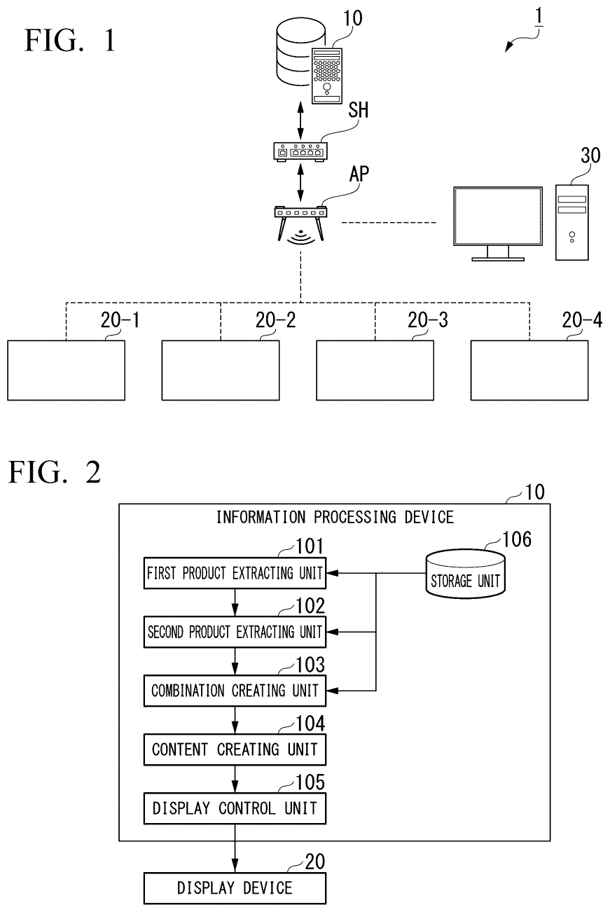

FIG. 1 is a diagram schematically illustrating a configuration of a display system according to an embodiment of the present invention. In this embodiment, the display system 1 is a system that controls display of content that is displayed on an electronic signboard such as a digital signage. The content may be associated with an advertisement for sales promotion of products, may be a still image or a moving image, and may have vocal sound or not. In this embodiment, the display system 1 displays content for notifying of and advertising discounted products (hereinafter referred to as “discounted products”) in stores such as grocery stores.

In the drawing, the display system 1 includes an information processing device 10, one or more display devices 20, and an external terminal 30. The information processing device 10, the display device 20, and the external terminal 30 are communicatively connected through a wired or wireless local area network (LAN) or a serial communication line. In the example illustrated in the drawing, the display device 20 and the external terminal 30 are communicatively connected to each other via an access point AP of the wireless LAN. The information processing device 10 is communicatively connected to the display device 20 or the external terminal 30 via a switching hub SH and an access point AP of the wireless LAN. A network which is constructed is not limited thereto as long as it is an environment in which the information processing device 10, the display device 20, and the external terminal 30 can communicate with each other.

The information processing device 10 is a computer that controls display of the display device 20. For example, the information processing device 10 outputs an image signal of content to the display device 20 such that the content is displayed on the display device 20.

The display device 20 is a digital signage for displaying content for advertisement on a display screen thereof. In the example illustrated in the drawing, the display system 1 includes four display devices 20, but the present invention is not limited thereto, and the number of display devices 20 may be three or less or five or more. In the following description, for the purpose of convenience of explanation, reference signs 1 to 4 are assigned to the four display devices 20, and the four display devices 20 are referred to as display devices 20-1, 20-2, 20-3, and 20-4. The reference signs 1 to 4 are omitted for elements common to the display devices 20-1 to 20-4, and the display devices 20-1 to 20-4 are simply referred to as “display devices 20” or “each display device 20.”

The external terminal 30 is a computer that is used for a seller to operate the information processing device 10 or the display devices 20.

FIG. 2 is a block diagram schematically illustrating a functional configuration of the information processing device according to the embodiment of the present invention.

The information processing device 10 includes a first product extracting unit 101, a second product extracting unit 102, a combination creating unit 103, a content creating unit 104, a display control unit 105, and a storage unit 106.

The first product extracting unit 101 extracts a first product of which a discount rate is equal to or greater than a first threshold value α.

The second product extracting unit 102 extracts a second product of which a discount rate is less than the discount rate of the first product.

The second product extracting unit 102 extracts a second product of which the discount rate is less than the discount rate of the first product and a difference in the discount rate from the first product is equal to or greater than a second threshold value β.

The combination creating unit 103 creates a plurality of different combinations of the first product and the second product which are advertised together. For example, the combination creating unit 103 combines the second product of which the discount rate is close to an average value of the discount rates with the first product of which the discount rate is high. The combination creating unit 103 combines the second product of which a stock quantity is large with the first product of which the discount rate is high. The combination creating unit 103 combines products of the same classification or similar classifications.

The content creating unit 104 creates content for advertising the first product and the second product together using materials or templates of images stored in advance in the storage unit 106. For example, the content creating unit 104 creates content for notifying of the discount rate of the first product and the discount rate of the second product. For example, the content creating unit 104 creates contents including the discount rate of the first product and the discount of the second product. The content creating unit 104 creates content of each of the plurality of combinations created by the combination creating unit 103.

The display control unit 105 outputs an image signal of the created content to the display device 20. Accordingly, the display control unit 105 causes the display device 20 to display the created content.

The storage unit 106 stores various types of data for display control of the display device 20. For example, the storage unit 106 stores templates or materials of images for creating content which is displayed by the display device 20. The storage unit 106 stores a product database indicating information of all products which are handled by stores.

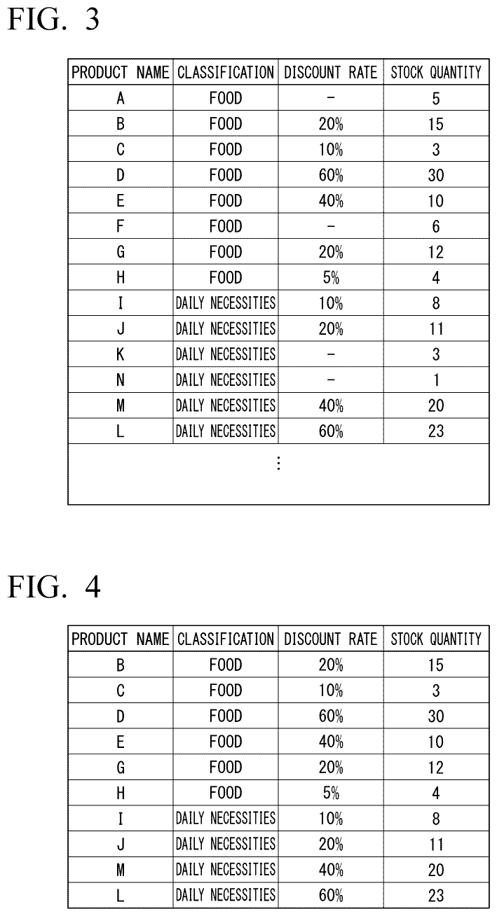

FIG. 3 is a diagram schematically illustrating a data structure and a data example of a product database according to the embodiment of the present invention.

As illustrated in the drawing, the product database includes entries such as a product name, a classification, a discount rate, and a stock quantity. The product name is a name of a product. The classification is a classification of a product. The discount rate is a ratio discounted from a fixed price of a product. The discount rate “-” indicates that discount is not applied (the discount rate is 0%). The stock quantity is a stock quantity of a product.

A specific example of operations that are performed by the information processing device 10 according to this embodiment will be described below in details. First, the first product extracting unit 101 extracts all discounted products of which the stock quantity is equal to or greater than 1 and which are discounted (that is, products with a discount rate other than “-”) out of all products with reference to the product database. The reason a product with a stock quantity equal to or greater than 1 is extracted is for preventing a product of which sale is not currently possible from being advertised.

FIG. 4 is a diagram schematically illustrating an example of extraction results of discounted products according to the embodiment of the present invention.

In the drawing, results of extraction of discounted products from all the products illustrated in FIG. 3 are illustrated. In the following description, a product with a product name “A” is referred to as “product A” for the purpose of convenience of explanation. In the illustrated example, products B to E, products G and J, and products M to L are extracted as discounted products with a stock quantity equal to or greater than 1.

Subsequently, the first product extracting unit 101 extracts a first product of which the discount rate is equal to or greater than the first threshold value β out of the extracted discounted products. The first product is a product which will be preferentially sold, that is, a product of which an advertisement for sales promotion will be preferentially displayed. The first threshold value α is a threshold value for a discount rate corresponding to preferential sale and is set in advance.

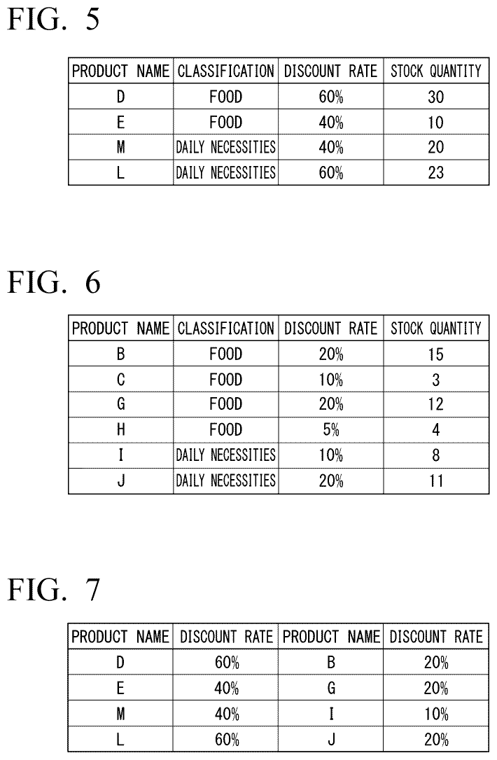

FIG. 5 is a diagram schematically illustrating an example of extraction results of the first product of which sale will be preferentially promoted according to the embodiment of the present invention.

In the drawing, results of extraction of the first product of which sale will be preferentially promoted from the discounted products illustrated in FIG. 4 are illustrated. In the example illustrated in the drawing, the first threshold value α is 40%. In the illustrated example, products D, E, M, and L are extracted as the first products.

Subsequently, the second product extracting unit 102 extracts a second product of which the discount rate is less than the first threshold value α and a difference in the discount rate from the first product is equal to or greater than the second threshold value β for each extracted first product out of the extracted discounted products. The second threshold value β is set in advance.

FIG. 6 is a diagram schematically illustrating an example of extraction results of the second product which is advertised along with the first product according to the embodiment of the present invention.

In the drawing, results of extraction of the second product which is advertised along with the first product out of the discounted products illustrated in FIG. 4 are illustrated. In the example illustrated in the drawing, the first threshold value α is 40%, and the second threshold value β is 20%. In this example, products B, C, G, H, I, and J are extracted as the second products for all the first products D, E, M, and L. That is, in this example, the extraction results of the second product for the first products D, E, M, and L are the same.

Subsequently, the combination creating unit 103 creates a plurality of combinations of products which are advertised together for the purpose of efficiently notifying of and advertising a plurality of discounted products. In this example, the combination creating unit 103 creates one combination including two products of one first product and one second product. For example, the combination creating unit 103 selects a second product to be combined with each of a plurality of extracted first products. First, the combination creating unit 103 extracts the second product with the same classification as the first product. For example, the combination creating unit 103 extracts the second products B, C, G, and H with a classification “food” for the first products D and E with a classification “food.” Similarly, the combination creating unit 103 extracts the products I and J with a classification “daily necessities” for the first products M and L with a classification “daily necessities.” It is possible to easily compare products which are advertised together by selecting the second product with the same classification as the first product.

Subsequently, the combination creating unit 103 calculates an average value γ of the discount rates of all the discounted products for each classification. Then, the combination creating unit 103 combines the second product with the same classification close to the average value γ sequentially from the first product with the highest discount rate. In this way, by sequentially combining the second products with a discount rate close to the average value γ with the first product with the highest discount rate, it is possible to curb extreme decrease in the difference of the discount rate by combinations. That is, it is possible to equalize the differences of the discount rates between the combinations.

At this time, the combination creating unit 103 preferentially selects the second product with a larger stock quantity when there are a plurality of second products in which differences of the discount rates from the average value γ are the same or similar (the differences are equal to or less than a predetermined value). Alternatively, the combination creating unit 103 may set the classifications in more detail (for example, middle classifications “lunch boxes” and “noodles” for a large classification “foods”) and select the second product of which a detailed classification is identical or similar to that of the first product.

FIG. 7 is a diagram schematically illustrating an example of a combination of the first product and the second product which are advertised together according to the embodiment of the present invention.

In the drawing, results of combinations of the first products illustrated in FIG. 5 and the second products illustrated in FIG. 6 are illustrated. In the example illustrated in the drawing, a combination of the first product D with a discount rate “60%” and the second product B with a discount rate “20%,” a combination of the first product E with a discount rate “40%” and the second product G with a discount rate “20%,” a combination of the first product M with a discount rate “40%” and the second product I with a discount rate “10%,” and a combination of the first product L with a discount rate “60%” and the second product J with a discount rate “20%” are created.

Subsequently, the content creating unit 104 creates content for an advertisement for each of the created combinations. That is, the content creating unit 104 creates content of the same number as the number of created combinations. For example, the content creating unit 104 combines an image indicating each product (for example, an illustration or a photograph of each product) and an image indicating the discount rate of the corresponding product.

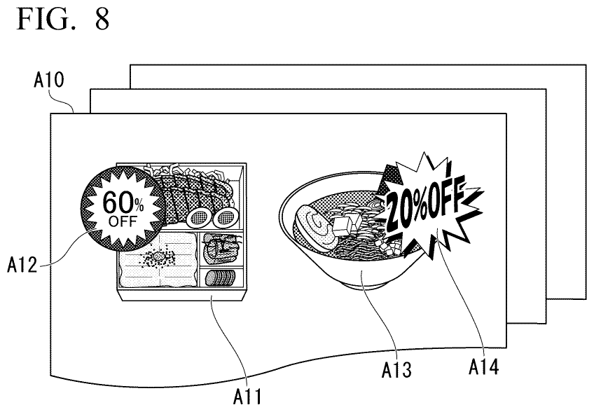

FIG. 8 is a diagram illustrating an example of an image of content for an advertisement according to the embodiment of the present invention.

As illustrated in the drawing, an image A11 of the first product, an image A12 indicating the discount rate of the first product, an image A13 of the second product, and an image A14 indicating the discount rate of the second product are displayed in content A10 for advertising the first product and the second product. That is, the content creating unit 104 creates content for notifying of the discount rate of the first product and the discount rate of the second product. In this way, by arranging and displaying the discount rate of the first product and the discount rate of the second product, it is possible to emphasize a bargain feeling in the first product with the difference of the discount rate. Accordingly, it is possible to concentrate an interest of customers having viewed the content on the first product and to stimulate a purchase desire for the first product. Accordingly, it is possible to promote sale of the first product which is wanted to be sold out.

Then, the display control unit 105 outputs an image signal indicating the created content to the display device 20. Accordingly, the display device 20 displays the content for advertising the first product and the second product. At this time, the display control unit 105 may sequentially display all the created content on the display device 20. For example, the display control unit 105 may sequentially display a plurality of pieces of content from the content for advertising the first product with the highest discount rate on the display device 20 in the form of a slide. Alternatively, the display control unit 105 may display a plurality of created pieces of content on a plurality of different display devices 20. For example, the display control unit 105 may display content for advertising the combination of the first product D and the second product B on the display device 20-1, display content for advertising the combination of the first product E and the second product G on the display device 20-2, display content for advertising the combination of the first product M and the second product I on the display device 20-3, and display content for advertising the combination of the first product L and the second product J on the display device 20-4. According to classifications of products to be advertised, the display control unit 105 may display the content on the display device 20 disposed in a selling area of the products of the classification. For example, when a classification of a product to be advertised is “food,” the display control unit 105 may display the content on the display device 20 disposed in a food selling area.

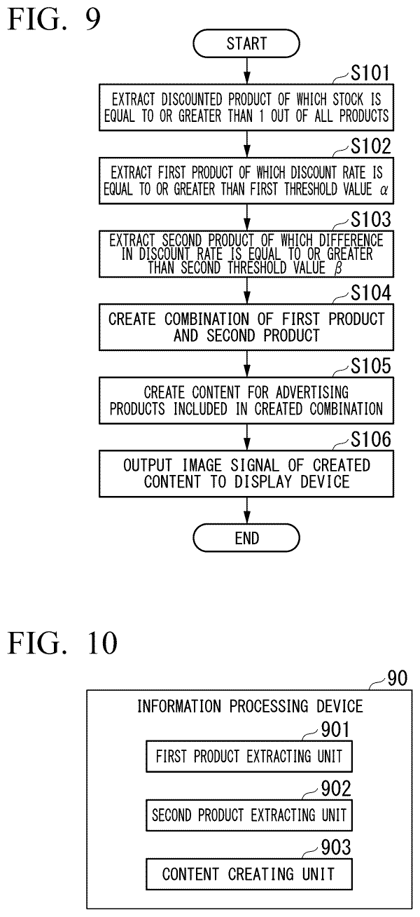

FIG. 9 is a flowchart illustrating an operation flow of a display process that is performed by the information processing device according to the embodiment of the present invention.

The information processing device 10 performs the operation flow illustrated in the drawing at intervals of a preset time. Alternatively, the information processing device 10 may perform the operation flow illustrated in the drawing when the product database is updated, for example, at a timing at which a product has been discounted, at a timing at which the discount rate has been changed, or at a timing at which the stock quantity has become 0.

First, the first product extracting unit 101 extracts all discounted products with a stock quantity equal to or greater than 1 out of all products with reference to the product database (Step S101). Subsequently, the first product extracting unit 101 extracts the first product of which the discount rate is equal to or greater than the first threshold value β out of the extracted discount products (Step S102). Subsequently, the second product extracting unit 102 extracts second products of which the discount rate is less than the first threshold value α and a difference of the discount rate from the first products is equal to or greater than the second threshold value β (Step S103).

Thereafter, the combination creating unit 103 creates a plurality of combinations of the first products and the second products which are advertised together (Step S104). Then, the content creating unit 104 creates advertisement content for advertising the products in the created combinations (Step S105). Thereafter, the display control unit 105 outputs image signals of the created content to the display device 20 such that the content is displayed on the display device 20 (Step S106). Thereafter, the operation flow ends.

In this way, the display system 1 according to this embodiment includes the first product extracting unit 101 configured to extract a first product of which a discount rate is equal to or greater than the first threshold value, the second product extracting unit 102 configured to extract a second product of which a discount rate is less than the discount rate of the first product, the content creating unit 104 configured to create content for advertising the first product and the second product together, and the display device 20 configured to display the created content.

With this configuration, since the first product of which the discount rate is equal to or greater than a predetermined value can be advertised along with the second product of which the discount rate is different therefrom, it is possible to concentrate purchase desires of consumers on the first product which is wanted to be early sold out. Accordingly, it is possible to notify of a plurality of discounted products together and to content purchase desires of consumers on products with high discount rates.

The content creating unit 104 creates content for notifying of the discount rate of the first product and the discount rate of the second product. With this configuration, since the difference between the discount rate of the first product and the discount rate of the second product can be notified of, it is possible to further emphasize a bargain feeling in the first product based on discount.

The display system 1 further includes the combination creating unit 103 configured to create a plurality of different combinations of the first product and the second product to be advertised together, and the content creating unit 104 creates content of each of the plurality of combinations. With this configuration, it is possible to efficiently notify of and advertise a plurality of discounted products.

The combination creating unit 103 combines the second product of which the discount rate is close to an average value of the discount rates with the first product of which the discount rate is high. With this configuration, it is possible to curb extreme decrease of the difference in the discount rate between specific combinations and to equalize the differences of the discount rate between the combinations.

The combination creating unit 103 combines the second product of which a stock quantity is large with the first product of which the discount rate is high. With this configuration, it is possible to increase opportunities to advertise the second product with a large stock quantity.

The combination creating unit 103 combines products of the same classification or similar classifications. With this configuration, it is possible to easily compare products which are advertised together.

FIG. 10 is a diagram illustrating an example of a configuration of another aspect of the information processing device according to the present invention.

An information processing device 90 illustrated in the drawing includes a first product extracting unit 901, a second product extracting unit 902, and a content creating unit 903.

The first product extracting unit 901 extracts a first product of which a discount rate is equal to or greater than a first threshold value.

The second product extracting unit 902 extracts a second product of which a discount rate is less than the discount rate of the first product.

The content creating unit 903 creates content for advertising the first product and the second product together.

Position detection may be performed by recording programs for realizing the functions of the information processing device illustrated in FIG. 2 on a computer-readable recording medium and causing a computer system to read and execute the programs recorded on the recording medium. The “computer system” mentioned herein includes an OS or hardware such as peripherals.

The “computer system” includes a homepage provision environment (or display environment) when a WWW system is used.

The “computer-readable recording medium” means a portable medium such as a flexible disk, a magneto-optical disc, a ROM, or a CD-ROM or a storage device such as a hard disk incorporated into the computer system. The “computer-readable recording medium” includes a medium that holds a program for a predetermined time such as a volatile memory in a computer system serving as a server or a client. The program may be for realizing some of the aforementioned functions or may be for realizing the aforementioned functions in combination with a program stored in advance in the computer system. The program may be stored in a predetermined server, and the program may be delivered (downloaded or the like) via a communication line in response to a request from another device.

While an embodiment of the present invention has been described above with reference to the drawings, a specific configuration of the present invention is not limited to the embodiment and includes design or the like without departing from the gist of the present invention.

For example, in the aforementioned embodiment, the combination creating unit 103 combines the first product and the second product of the same classification, but the present invention is not limited thereto, and a first product and a second product of similar classifications may be combined or a first product and a second product of different classifications may be combined.

In the aforementioned embodiment, the information processing device 10 creates content in which one first product and one second product are combined, but the present invention is not limited thereto, and content for advertising one or more first products and one or more second products together may be created. For example, the information processing device 10 may create content for advertising one first product and a plurality of second products together, create content for advertising a plurality of first products and one second product together, or create content for advertising a plurality of first products and a plurality of second products together. When a plurality of first products or second products are advertised together, the information processing device 10 may advertise first products or second products of which the discount rates of the first products or the second products are the same or similar (a difference therebetween is equal to or less than a predetermined value) together.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1 Display system
10, 90 Information processing device
101, 901 First product extracting unit
102, 902 Second product extracting unit
103 Combination creating unit
104, 903 Content creating unit
105 Display control unit
106 Storage unit
20 Display device
30 External terminal

What is claimed is:

1. An information processing device comprising:
a first product extracting unit configured to extract a first product having a first discount rate which is equal to or greater than a first threshold value;
a second product extracting unit configured to extract a second product having a second discount rate which is less than the first discount rate of the first product; and
a content creating unit configured to create advertisement-contents for advertising the first product and the second product together.

2. The information processing device according to claim 1, wherein the second product extracting unit is configured to extract the second product having the second discount rate which is less than the first discount rate of the first product, and wherein a difference of the first discount rate from the second discount rate is equal to or greater than a second threshold value.

3. The information processing device according to claim 1, wherein the content creating unit is configured to create notification-contents for notifying of the first discount rate of the first product and the second discount rate of the second product.

4. The information processing device according to claim 1, further comprising:
a combination creating unit configured to create a plurality of different combinations of the first product and the second product which are to be advertised together, wherein the first product is included in a first discount-rate-group of products which are equal to or greater in the discount rate than the first threshold value, and the second product is included in a second discount-rate-group of products which are equal to or greater in the discount rate than the second threshold value, and
wherein the content creating unit is configured to create respective advertisement-contents for each of the plurality of combinations.

5. The information processing device according to claim 4, wherein the combination creating unit is configured to combine the second product, which is closer in discount rate to an average value of all discount rates of all products which are subject to discount, with the first product which is higher in the discount rate than the average value.

6. The information processing device according to claim 4, wherein the combination creating unit is configured to combine the second product, of which a quantity of stock is larger than other second products in the second discount-rate-group of products, with the first product which is higher in the discount rate than the average value.

7. The information processing device according to claim 4, wherein the combination creating unit is configured to combine the first product and the second product which are classified in the same or similar classification.

8. A display system comprising:
a first product extracting unit configured to extract a first product having a first discount rate which is equal to or greater than a first threshold value;
a second product extracting unit configured to extract a second product having a second discount rate which is less than the first discount rate of the first product;
a content creating unit configured to create advertisement-contents for advertising the first product and the second product together; and
a display device configured to display the created content.

9. An information processing method that is performed by a computer, the information processing method comprising:
extracting a first product having a first discount rate which is equal to or greater than a first threshold value;
extracting a second product having a second discount rate which is less than the first discount rate of the first product; and
creating advertisement-contents for advertising the first product and the second product together.
